(19) United States
(12) Patent Application Publication
(10) Pub. No.: US 2012/0062488 A1
(43) Pub. Date: Mar. 15, 2012

(54) PREVENTION AGAINST REMISS TOUCH ON A TOUCHPAD

(75) Inventors: YEN-YU LIN, NEW TAIPEI CITY (TW); YING-CHIEH CHUANG, TAIPEI CITY (TW); JUI-TING KUO, TAICHUNG CITY (TW)

(73) Assignee: ELAN MICROELECTRONICS CORPORATION, HSINCHU (TW)

(21) Appl. No.: 13/227,530

(22) Filed: Sep. 8, 2011

(30) Foreign Application Priority Data
Sep. 13, 2010 (TW) 099130922

(51) Int. Cl. G06F 3/041

(52) U.S. Cl. 345/173

(57) ABSTRACT

A touchpad is defined with two or more detect regions thereon, and each of the defined detect regions has a respective remiss threshold for identifying remiss touch. When any of the defined detect regions is touched, the touchpad compares the touch area of the detected touch with the remiss threshold of the touched detect region to identify whether the detected touch is a remiss touch or not. Preferably, the location, range and threshold setting of the detect region is user defined, so that a user may adjust the remiss setting for optimized prevention against remiss touch.

### FIELD OF THE INVENTION

The present invention is related generally to a touchpad and, more particularly, to prevention against remiss touch on a touchpad.

### DESCRIPTION OF RELATED ART

For prevention against remiss touch, a touchpad is conventional set with a threshold range for touch area comparison that is to be compared with the touch area of an object's touch on the touchpad to identify whether the touch is a remiss touch or not. If a touch has a touch area within the preset threshold range, it will be regarded as an effective touch and the touchpad will do normal behavior; otherwise the touch will be regarded as a remiss touch and will be ignored by the touchpad. Therefore, the performance of prevention against remiss touch is highly relied on how the area threshold for identifying remiss touch is set. If a tight policy is taken for identifying remiss touch, for example defining a small threshold for touch area comparison, misadjugment would often happen and thereby obstruct the user's normal operation with the touchpad; on the contrary, a loose policy for identifying remiss touch would result in poor prevention against remiss touch.

The incidence of remiss touch on a touchpad is also related to the relative location of the touchpad with respect to other input devices and the mechanical design of the device where the touchpad is installed. For example, referring to FIG. 1, a notebook computer is typically designed to have the arrangement of a touchpad 10 below a keyboard 12, and thus the touchpad 10 will be likely to be unintentionally touched by the user's palms 14 and 16 when the user is typing on the keyboard 12. Moreover, different users have different palm sizes and thus will have different touch areas of remiss touch on the touchpad 10. For users having larger palms, the touch area of remiss touch will be larger, and thus the touchpad 10 needs a larger area threshold for identifying remiss touch to avoid the touchpad 10 more likely to misadjudge. Contrarily, a smaller area threshold is needed for users having smaller palms to correctly identify each remiss touch. Therefore, no area threshold setting will be suitable for all users.

The incidence of remiss touch on a touchpad is further related to the user's habit of operating the device where the touchpad is installed. For example, referring to FIG. 1 again, a left-handed person will be likely to have remiss touch on the left half of the touchpad 10, while a right-handed person will tend to have remiss touch on the right half of the touchpad 10. No existing mechanism for prevention against remiss touch is adjustable or adaptive to the user's habit.

In view of that the existing mechanism for prevention against remiss touch is not good enough to identify remiss touch in various conditions, a better solution is needed.

### SUMMARY OF THE INVENTION

An objective of the present invention is to provide a method for better prevention against remiss touch on a touchpad.

Another objective of the present invention is to provide a touchpad having better prevention against remiss touch.

A further objective of the present invention is to provide a control method for a touchpad adaptive to operation with the touchpad.

According to the present invention, a touchpad is defined with a plurality of detect regions thereon, each of the defined detect regions having a respective remiss threshold for identifying remiss touch. When any of the defined detect regions is touched, the touchpad compares the touch area of the detected touch with the remiss threshold of the touched detect region to identify whether the detected touch is a remiss touch or not. Preferably, the location, range and threshold setting of the detect region is user defined, so that a user may adjust the remiss setting for optimized prevention against remiss touch.

### BRIEF DESCRIPTION OF THE DRAWINGS

These and other objectives, features and advantages of the present invention will become apparent to those skilled in the art upon consideration of the following description of the preferred embodiments according to the present invention taken in conjunction with the accompanying drawings, in which:

FIG. 1 is a schematic diagram of the typical arrangement of input devices on a notebook computer and the situation of a user operating therewith;

FIG. 2 is a schematic diagram of an embodiment according to the present invention;

FIGS. 3 and 4 are schematic diagrams of embodiments according to the present invention applied to a notebook computer;

FIG. 5 is a schematic diagram of an embodiment according to the present invention applied to a cell phone; and

FIG. 6 is a flowchart of a control method for a touchpad according to the present invention.

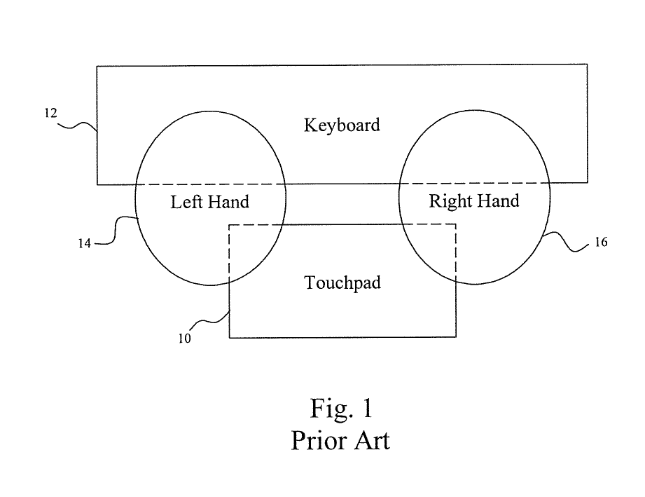

### DETAILED DESCRIPTION OF THE INVENTION

According to the present invention, a touchpad is defined with two or more detect regions thereon, each of the detect regions having a respective remiss threshold for prevention against remiss touch thereon. For a detect region more likely to be touched in error, a tighter remiss policy is taken for the remiss threshold setting, and thus enhances the performance of prevention against remiss touch. Preferably, the location, range and threshold setting for the detect regions defined on a touchpad are user programmable, so that a user may adjust the remiss setting for optimized prevention against remiss touch, for example, in consideration of the mechanical design of a device where the touchpad is installed and the user's habit of operating a device where the touchpad is installed.

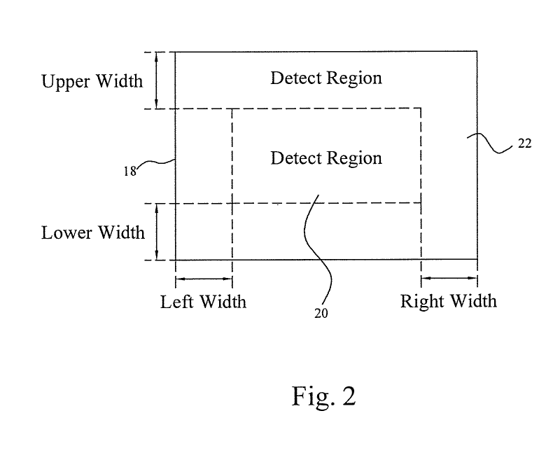

In an embodiment according to the present invention, referring to FIG. 2, a touchpad 18 is defined with two detect regions 20 and 22 thereon, where the detect region 20 is given a loose remiss threshold setting and the detect region 22 is given a tight remiss threshold setting. The location, range and threshold of each of the detect regions 20 and 22 can be adjusted by users, for example, according to the mechanical design of the device where the touchpad 18 is installed and the user's habit of operating therewith, to reduce the incidence of remiss touch. In an embodiment, to adjust the ranges of the detect regions 20 and 22, four user defined values are set for the upper, lower, left and right widths, respectively, to define the detect regions 20 and 22 in a simple way. Therefore, any user is allowed to define the detect region 20 smaller or larger.

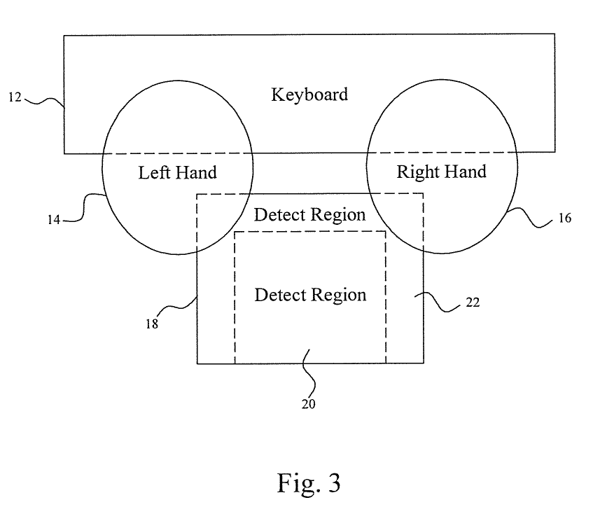

When the touchpad 18 shown in FIG. 2 is applied to a notebook computer in a typical arrangement, referring to FIG. 3, the user's left and right hands 14 and 16 are likely to have remiss touch on the upper-left and upper-right corners of the touchpad 18 when the user operates the keyboard 12. In this case, the detect region 22 is defined on an edge including the upper-left and upper-right corners of the touchpad 18, and is given a small remiss threshold for identifying remiss touch. Therefore, most of the remiss touches on the detect region 22 will be correctly identified and ignored by the touchpad 18. The other detect region 20 is set with the lower width shown in FIG. 2 equal to zero, and is given a large remiss threshold for identifying remiss touch since it is at the place less likely to be touched unintentionally.

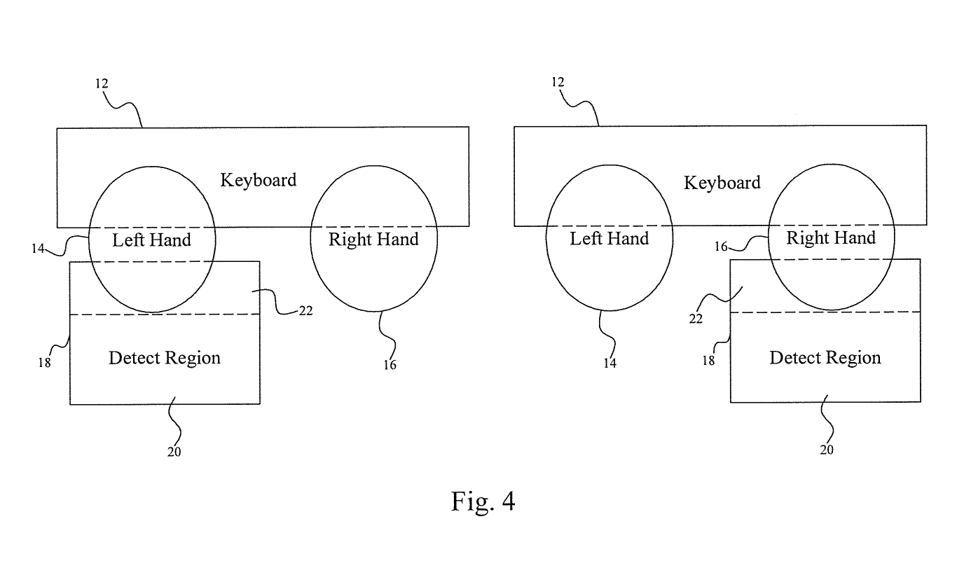

When the touchpad 18 shown in FIG. 2 is applied to a notebook having a different mechanical design, the detect region 22 on the touchpad 18 may have its location and range adjusted, for example, as shown in FIG. 4. In these cases, the touchpad 18 is located near the lower-left corner or lower-right corner of the keyboard 12, and thus the upper edge of the touchpad 18 is most likely to have remiss touch. Therefore, the upper edge of the touchpad 18 is defined as the detect region 22, and is given a small remiss threshold for identifying remiss touch. The other detect region 20 may be given a very large remiss threshold to makes it not sensitive to remiss touch since it is not likely to be touched unintentionally.

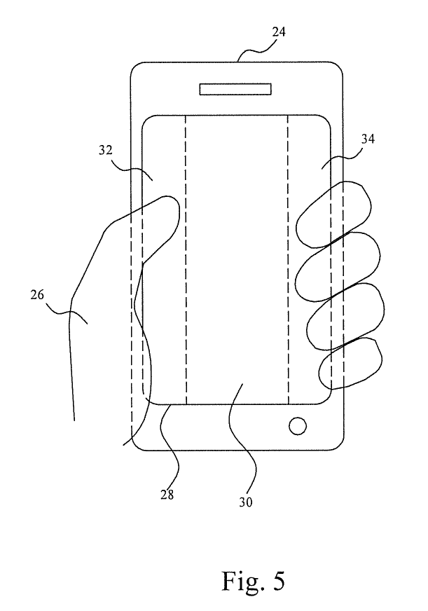

Referring to FIG. 5, a cell phone 24 having a touchpad 28 also has the problem of remiss touch when a user holds the cell phone 24. In this case, it is the left edge 32 and right edge 34 of the touchpad 28 more likely to be unintentionally touched by the user's fingers. For this reason, the left edge 32 and right edge 34 of the touchpad 28 are defined as a detect region given a small remiss threshold for identifying remiss touch, and the middle region 30 of the touchpad 28 is defined as another detect region given a large remiss threshold for identifying remiss touch. Since the size of the user's palm 26 is different user by user, it is designed the range of the detect region 32 and 34 adjustable by users. In some other embodiments, the touchpad 28 is defined with three detect regions 30, 32 and 34 given different remiss thresholds respectively, for example, according to the user's habit of operating the cell phone 24.

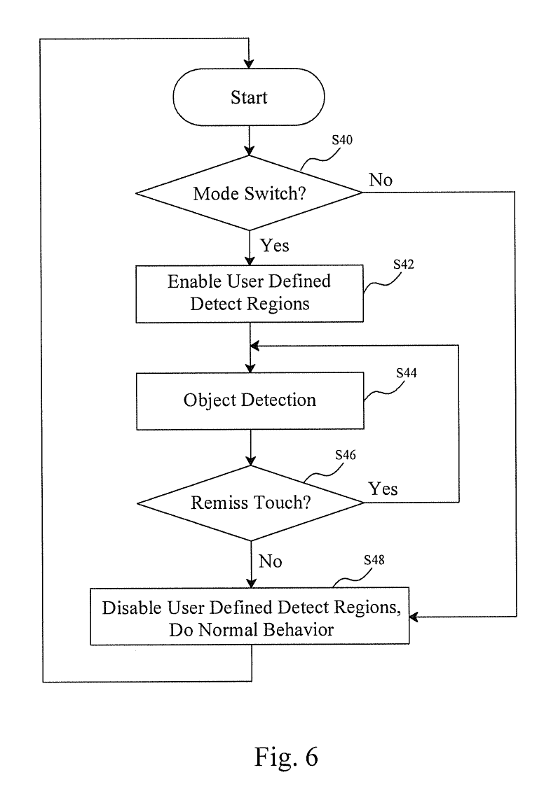

FIG. 6 is a flowchart of a control method for a touchpad according to the present invention. In this embodiment, a touchpad has two modes. When the touchpad is used as the major input interface, the touchpad is switched to the first mode for normal operation, in which the touchpad as a whole is regarded as a single detect region having a single remiss threshold as conventional, while the remiss threshold is given a relatively large value; otherwise, the touchpad operates in the second mode and is defined with a plurality of detect regions having different remiss thresholds. In the process, step S40 decides whether to switch the operational mode or not. In different applications, different conditions for this judgment may be used. For example, in the case of a notebook computer on which its keyboard is being used or in the case of a cell phone on a voice call, where the touchpad is not in use, step S42 is performed to switch the touchpad to the second mode and enable the user defined detect regions, and then step S44 performs object detection. If a touch is detected, its location and touch area on the touchpad will be calculated as a conventional touchpad did. By comparing the touch area of the detected touch with the user defined remiss threshold of the touched detect region, step S46 identifies whether the detected touch is a remiss touch or not. If it is not a remiss touch, meaning that the user needs to use the touchpad for normal operation, step S48 is performed to disable the user defined detect regions and switch the touchpad to the first mode to do normal behavior. If step S46 identifies a remiss touch, the detected touch will be ignored and the process will go back to step S44 for object detection again.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A method for prevention against remiss touch on a touchpad, comprising the steps of:
enabling a plurality of detect regions defined on the touchpad, each of the defined detect regions having a respective remiss threshold for identify remiss touch;
if a touch on the touchpad is detected, calculating a location and a touch area of the touch; and
if the location is in one of the defined detect regions, comparing the touch area with the corresponding remiss threshold of the touched detect region for identifying whether the detected touch is a remiss touch or not.

2. The method of claim 1, further comprising the step of adjusting at least one of a location, a range and the remiss threshold of one of the defined detect regions.

3. A touchpad with prevention against remiss touch, comprising:
a first detect region defined on the touchpad; and
a second detect region defined on the touchpad;
wherein each of the first and second defined detect regions has a respective remiss threshold to be compared with a touch area of a touch thereon, for identifying whether the touch is a remiss touch or not.

4. The touchpad of claim 3, wherein each of the first and second detect regions has a respective location and range which are user defined and adjustable, and each of the remiss thresholds is user defined and adjustable.

5. A control method for a touchpad, comprising the steps of:
switching the touchpad between two modes;
if a touch is detected on the touchpad when the touchpad operates in the first mode, comparing a touch area of the detected touch with a first remiss threshold for identifying whether the detected touch is a remiss touch or not;
enabling a plurality of detect regions defined on the touchpad when the touchpad is switched to the second mode, wherein each of the defined detect regions has a respective second remiss threshold for identify remiss touch; and
if a touch is detected on one of the defined detect regions when the touchpad operates in the second mode, comparing a touch area of the detected touch with the corresponding second remiss threshold of the touched detect region for identifying whether the detected touch is a remiss touch or not.

6. The control method of claim 5, further comprising the step of adjusting at least one of a location, a range and the second remiss threshold of one of the defined detect regions.

7. The control method of claim 5, further comprising the step of disabling the defined detect regions when the touchpad operates in the second mode and a touch is identified not a remiss touch, and then switching the touchpad to the first mode.
